(19) United States
(12) Patent Application Publication
(10) Pub. No.: US 2003/0019243 A1
(43) Pub. Date: Jan. 30, 2003

(54) Procedure to mark groove traces of grooves induced by laser

(76) Inventors: Stefan Biethmann, Alfeld (DE); Ludger Terstriep, Mainz (DE); Dirk Hauer, ElIwurdem (DE); Thomas Schmidt, Delligsen (DE); Hartmut Glenewinkel, Coppengrave (DE)

Correspondence Address: BAKER & DANIELS, 111 E. WAYNE STREET, SUITE 800, FORT WAYNE, IN, 46802

(21) Appl. No.: 10/171,866

(22) Filed: Jun. 17, 2002

(30) Foreign Application Priority Data
Jun. 21, 2001 (DE) 101 29 876.5

(51) Int. Cl. C03B 33/09

(52) U.S. Cl. 65/112; 225/2; 83/16; 427/292

(57) ABSTRACT

The invention concerns a procedure to mark groove traces of laser-induced grooves of glass components by optical visualization.

The invention is characterized by the fact that the optical visualization is created by a at least partial application of a coating on the groove trace.

The invention concerns a procedure to mark groove traces of laser-induced grooves in glass, in detail with the features from the generic term of claim 1; furthermore a procedure for dividing glass components into a number of glass sub components.

From the publication DE-AS 1244 346 a procedure for laser-induced cutting of glass is well-known, with which a temperature rise of the glass is created along the cutting course by means of a laser beam, whereby a temperature below the melting temperature of the glass is set. Following the temperature rise the glass is cooled and separated by knocking or bending. With such a procedure, apart from when the temperature rises above the melting temperature, which leads to melting out of a fine gap, the groove trace is not perceptible. For the possible visual perceptibility of the groove trace with the desired separation of the glass components, in particular flat glass disks, a visual marking so far took place via breathing on the groove trace while applying a low bending stress. Furthermore this cut is manually averaged between the fingers, in order to then break the disk and/or the glass component. The disadvantage of this procedure consists above all of the fact that the visibility is limited very much to a temporary time and if the glass is not immediately positioned and broken it is necessary to breathe on the glass again, in order to ensure the perceptibility of the groove and to enable thus a clean breaking process. The groove marking, i.e. the procedure for the perceptibility of the groove trace, is the requirement that the groove and/or the groove trace lies centrically between the fingers and thus a symmetrical distribution of force can be ensured for the break, since otherwise the glass component, in particular the flat glass disk, is separated under a bevel resulting thereby in break smears at the breaking edge.

Another procedure, in which a marking is applied before creating the groove, is well known from JP 053 05 567 A. In this procedure the marking of the to be created groove trace takes place by means of a absorbent on the glass surface, which is separated afterwards by means of a laser, in particular by a YAG laser. This absorbent is required, in order to be able to cut glass components by means of the mentioned laser technology at all. The absorbent serves thereby besides the marking of the separation process also the purpose to create the temperature rise of the glass.

It is an object of the invention to improve a procedure for the groove trace marking of laser-induced grooves in glass and/or in glass components and a procedure for the partitioning of glass components into several glass sub components in such a way that the perceptibility of the groove trace is ensured independently of external effects and also for the case of an extension of the length of time for the accurate adjustment of the glass components during breaking. The marking is to be realized at low design and control technical expenditure.

The features of the claims 1 and 12 characterize the solution according to the invention. Favorable embodiments are shown in the sub claims.

In the procedure for groove trace marking of laser-induced grooves in glass components and/or glass the groove and/or the groove trace are made visually perceptible after being created and before the break process, in order to achieve an accurate positioning of the glass component and symmetrical distribution of force. According to the invention the visual perceptibility is ensured via the at least partial application of a coating on the groove trace. The visual perceptibility is ensured thereby by a coating color selected differently from the color of the surfaces of the glass components and/or by a surface bump on the groove trace caused by the layer thickness. A further possibility consists in the perceptibility of the marking through additional UV irradiation. With the solution according to the invention it is possible, to make the groove traces created during the laser-induced cutting of glass and/or glass components perceptible in a simple way for a longer period of time, whereby a removal takes place if desired, i.e. optionally, for example by washing the individual glass part components after the break process. This perceptibility for a longer period of time enables during the separation process of glass components, in particular flat glass disks, a very accurate and faster adjustment of the groove trace during the separation, in particular breaking. Thus a higher productivity can be achieved with glass cutting, since now the break process becomes the speed-determining factor of the total process. The expenditure for a required rework and/or the percentage of scrap parts can be substantially reduced.

For the application of the coating on the groove trace several possibilities exist:

a) Constant over the total length of the groove trace or

b) Application of single layers in certain distances over the length of the groove trace, so that between the individual groove trace areas with coating groove trace areas without a coating are present.

The possibility mentioned in b) is in particular of importance for groove traces with longer length, since here only mark points or marking areas are created, which are considered as reference point for the further separation process and—according to the selected coating—the removal of the markings after the completed separation process can be realized in an easy manner.

Concerning the choice of the applied coating a number of possibilities exist. The coating can be transparent or not transparent. This depends thereby in particular on the colored design of the glass component to be separated. If a transparent coating is chosen for the purpose of the marking thereby a coating with a different color than that of the glass component is preferably selected. In the case of not transparent coating this is not required.

The term coating is understood in detail as the application of a certain amount of liquid or a liquid air mixture with a curing agent on a surface, whereby the coating can be present according to the layer thickness as a film or a spray or a layer. Preferably according to the selected coating process layers with a very low layer thickness, i.e. coatings in form of a film or a spray are selected. The coating can be applied thereby in detail by a jet device, a pin or a spray device. In the first mentioned case thereby the application of a liquid, which hardens, takes place. In the second case particles are set free from a solid material, which are applied on the surface or however a certain amount of hardening liquid is applied through pressure on a storage medium. In the third case the application take places via atomization of the liquid and disposition of it on the surface, whereby in the latter procedure not only the groove trace is covered, but usually also the area beside the groove trace. Therefore the first two procedures can also be called direct marking procedures, while spraying is usually to be called an indirect procedure.

Concerning the specific arrangement of the individual marking systems likewise a number of possibilities exists. In the case of applying the coating as jet at least one jet device, containing at least one application nozzle, is intended. The design of the marking system for the purpose of the marking by means of a pin comprehends a pin holding device and a pin guiding device, which guides the pin and/or which contains the pin as the application device, which releases either through pressure on a storage medium a suitable amount at application liquid. If designed as a spraying system this comprehends a nozzle, in which the liquid is mixed with air or another gas and than released as a spray.

In all three cases thereby the release device for the marking system can be stationary, i.e. the application of the groove trace marking takes place during relative motion of the glass component in relation to the application device and/or release device. In the other case the application device and/or release device is mobile guided in relation to the surface of the glass component and thus the groove trace. The imbedding of the groove trace marking into a separation process according to the invention takes place between the laser-induced cutting and the actual separation process, the breaking. According to the selected kind of coating it is required to submit the glass part components available after separation to a washing process.

The solution according to the invention is following described using figures. Following is shown individually:

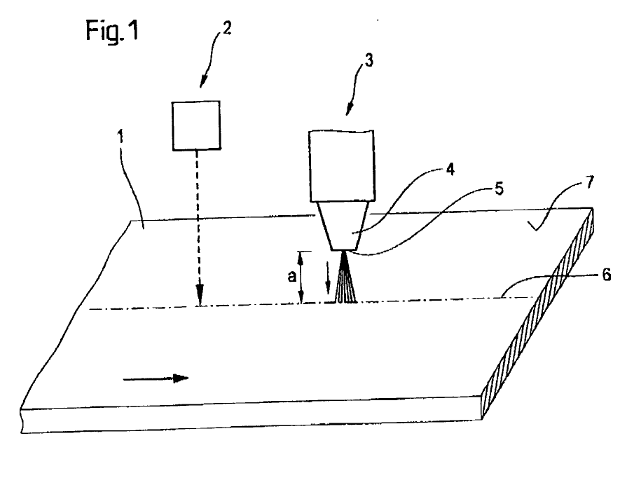

FIG. 1 explains in a schematized and strongly simplified view a device for the separation of glass components the working principle of a marking system with jet application;

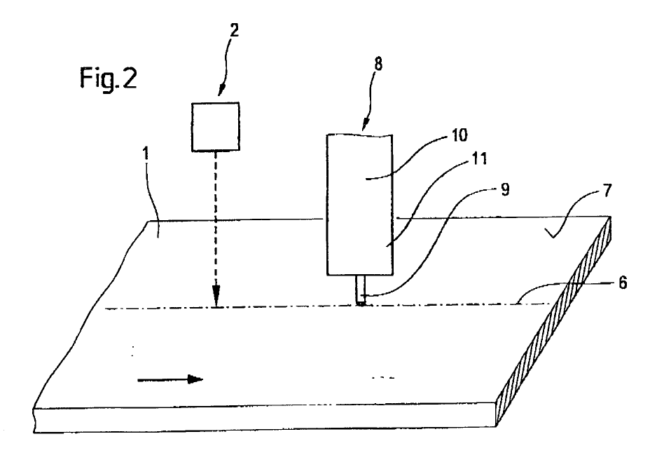

FIG. 2 explains in a schematized and simplified view a design of the marking system with pin marking according to an embodiment of FIG. 1;

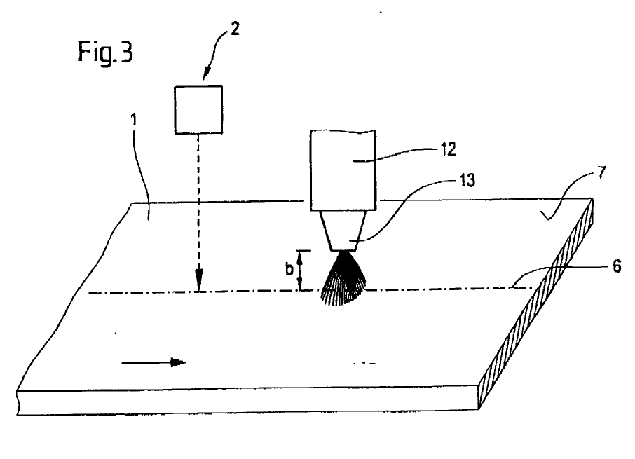

FIG. 3 explains the design of a marking system with spray marking according to an embodiment of FIG. 1.

FIG. 1 explains in a schematized and strongly simplified view for a glass component 1 a device 2 for laser-induced cutting, which is assigned to this glass component and is only schematically indicated, and a marking system 3 according to the invention. In this design the device for laser-induced cutting 2 and the marking system 3 are stationary, i.e. immobile in relation to the glass component arranged, and the glass component 1 is moved relative to the suitable function units of this device and/or the marking system 3. The specific design of the device for laser-induced cutting 2 is not explained any further at this point. Therefore no restrictions exist for the choice of the marking system. The marking system 3 contains in the represented case at least one application device 4 in form of a nozzle, which emits a jet, for example in form of a free jet, i.e. between the outlet 5 of the application device 4 and the groove trace 6, which is created at the surface 7 of the glass component, is a certain distance a. The nozzle and/or the application device 4 however can also run into direct proximity of the surface, so that a free jet is no longer given and the application basically takes place directly.

FIG. 2 explains a similar design of the FIG. 1, whereby however a pin 9 is intended as application device 8 of the marking system 3, which releases from a storage device 10 a liquid containing a curing agent or particles which stick to the surface 7 of the glass component. Thereby a control device 11 is assigned to the pin 9, which likewise is located stationary in relation to the glass component 1, i.e. not mobile.

FIG. 3 explains a further design of a marking system 3, containing a setting 12 for the generation of a spray, containing at least one spray nozzle 13. This is arranged likewise in a certain distance b in relation to the surface 7 of the glass component, so that with the release from the spray nozzle 13 a distribution over an area on both sides of the groove trace 6 takes place. Preferably in all described designs of the marking system all individual components concerning the positioning are connected to the device for laser-induced cutting. The solution according to the invention is not limited to the designs represented in the figures. Further embodiments are possible. It is crucial that the marking takes place by a layer that holds for a longer period of time, for example in form of a film or a spray, whereby this layer and/or the spray is to be differentiated visually from the surface of the glass area.

Reference Symbol List

1 Glass component

2 Device for laser-induced scratching of glass components

3 Marking system

4 Application device

5 Outlet of a nozzle

6 Groove trace

7 Surface

8 Application device

9 Pin

10 Storage

11 Control device

12 Setting for the generation of a spray

13 Spray nozzle

a Distance between outlet of the application device 4 and the surface 7 of the glass component 1

b Distance between outlet of the spray nozzle 13 and the surface 7 of the glass component 1

1. Procedure for the groove trace marking of laser-induced grooves of glass components by optical visualization, characterized by the fact that the optical visualization is created by applying a coating on the existing groove trace with a marking system.

2. Procedure according to claim 1, characterized by the fact that the coating is applied continuous over the whole groove trace.

3. Procedure according to claim 1, characterized by the fact that the coating is applied only on individual areas of the groove trace.

4. Procedure according to one of the claims 1 to 3, characterized by the fact that the coating takes place with a coating material of different color than the color of the surface of the glass component.

5. Procedure according to one of the claims 1 to 4, characterized by the fact that the coating is applied with a thickness, whereas the visual perceptibility takes place at least over the layer thickness.

6. Procedure according to one of the claims 1 to 4, characterized by the fact that the coating is applied as a film with small layer thickness.

7. Procedure according to one of the claims 1 to 6, characterized by the fact that a transparent coating is applied.

8. Procedure according to one of the claims 1 to 6, characterized by the fact that a non-transparent coating is applied.

9. Procedure according to one of the claims 1 to 8, characterized by the fact that the coating is applied by means of a free jet.

10. Procedure according to one of the claims 1 to 9, characterized by the fact that the coating is applied as spray, in form of a mixture of a coating medium and a gas.

11. Procedure according to one of the claims 1 to 9, characterized by the fact that the application is made over the length of the groove trace via relative motion of the glass component in relation to the marking system.

12. Procedure according to one of the claims 1 to 11, characterized by the fact that the coating is applied immediately after creating the groove.

13. Procedure for dividing glass components into a number of glass sub components, during which at least one groove trace is created laser-induced within the desired separation area, the groove trace thereafter is marked and an adjustment of the glass component for the conduction of the breaking process using the marking takes place, characterized by the fact that the groove trace marking takes place in a procedure according to one of the claims 1 to 12.
